(19) United States
(12) Patent Application Publication
(10) Pub. No.: US 2025/0140053 A1
(43) Pub. Date: May 1, 2025

(54) COMMUNITY GAMING AND TOURNAMENTS IN THE METAVERSE

(71) Applicant: IGT, Las Vegas, NV (US)

(72) Inventors: Bethany PLIMMER, Lower Coverdale (CA); Aaron COREY, Moncton (CA); Gaurav JARIWALA, Halifax (CA); David FROY, Lakeville-Westmorland (CA); Fayez IDRIS, Dieppe (CA); Jackie ALVAREZ, Las Vegas, NV (US); Michael RUSS, Graz (AT)

(73) Assignee: IGT, Las Vegas, NV (US)

(21) Appl. No.: 18/496,418

(22) Filed: Oct. 27, 2023

(51) Int. Cl. G07F 17/32

(52) U.S. Cl. CPC G07F 17/3211; G07F 17/323; G07F 17/3237; G07F 17/3276; G07F 17/3288

(57) ABSTRACT

A gaming device includes an input device, a processor circuit and a memory coupled to the processor circuit. The memory includes machine-readable instructions that, when executed by the processor circuit, cause the processor circuit to perform operations herein. Operations include providing an online virtual environment that includes a wagering tournament game that is accessible to multiple users in different physical locations. Operations include receiving, via the input device and from the users, login credentials that provide the users with access to the online virtual environment and providing access to the online virtual environment using multiple gaming channels that includes a first gaming channel and a second gaming channel that is different from the first gaming channel. Operations include providing image data received from an image capture device of one of the users with other ones of the users in the online virtual environment.

### BACKGROUND

Embodiments herein relate to slot tournaments and community gaming. Slot tournaments have been offered in land-based casinos for many years. Typically, a casino may offer slot tournaments as a promotion to attract players to the casino. The tournament participants may sign up to play in the slot tournament. An entry fee is often charged to the players, but this is not universal. EGMs used for the tournament may be placed into a “tournament mode”. A common implementation is an “out-of-revenue” tournament, in which no real money or credits are inserted into the EGMs, allowing the participants to play the game for free (aside from the initial entry fee, if any). The players may typically have a fixed amount of time to play and earn as many credits as possible before the time expires. In some cases, the participating EGMs may be connected to a tournament controller that monitors the accumulated points on each EGM and displays a leaderboard on an overhead sign so the participants and audience can see in real time what the point standing are during the tournament. Using a controller makes it easier to operate the tournament since casino personnel may not need to manually check each player's score at the end and may help add to the excitement and entertainment value of the tournament. It may be advantageous to expand the participation in a tournament or community game to a larger audience.

### BRIEF SUMMARY

According to some embodiments, a gaming device includes a display device, a biometric feedback device, a processor circuit and a memory including machine-readable instructions. When executed by the processor circuit, the instructions cause the processor circuit to provide a graphical user interface (GUI) that includes a virtual casino. Some embodiments provide that the virtual casino may be accessed by multiple users simultaneously. For example, multiple users may participate in an on-line tournament and/or a community game. The processor circuit may be caused to receive login credentials from the multiple users. The login credentials may be evaluated and, based on the login credentials being valid, the user may be provided with access to the virtual casino. Some embodiments provide that access to the virtual casino may be provided using multiple different gaming channels. Gaming channels may include channels between the virtual casino and a land-based EGM in the same physical location, land-based EGM's in different physical locations, mobile computing devices located locally and/or mobile computing devices that are remotely located.

Some embodiments are directed to methods, systems and/or devices that perform operations disclosed herein. The operations include providing an online virtual environment that includes community games that are accessible to multiple users and receiving, from the users, login credentials that provide the users with access to the online virtual environment. Operations may include providing access to the online virtual environment using multiple gaming channels that include a first gaming channel having a first gaming channel type and a second gaming channel having a second gaming channel type that is different from the first gaming channel type. In some embodiments, AI may be used to provide a simulated audience in the online virtual environment by providing a non-player character therein.

Provided is a flowchart illustrating operations for a gaming device according to some embodiments herein. The gaming device may include an input device, a processor circuit, and a memory coupled to the processor circuit. The memory includes machine-readable instructions that, when executed by the processor circuit, cause the processor circuit to perform operations including providing an online virtual environment that includes a wagering tournament game that is accessible to multiple users in different physical locations. Operations may further include receiving, via the input device and from the users, login credentials that provide the users with access to the online virtual environment. Operations may include providing access to the online virtual environment using multiple gaming channels. Some embodiments provide that the multiple gaming channels include a first gaming channel and a second gaming channel that is different from the first gaming channel. Operations include providing image data received from an image capture device of one of the users with other ones of the users in the online virtual environment.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIGS. 2F and 2G illustrate VR/AR devices according to various embodiments.

FIG. 3 is a schematic block diagram illustrating providing shared tournaments between two or more gaming channels according to some embodiment herein.

FIG. 4 is a schematic block diagram illustrating a graphical user interface (GUI) for customizing a virtual casino according to some embodiments herein.

FIG. 5 is a shared virtual environment comprising a virtual casino is illustrated according to some embodiments.

FIG. 6 is a flowchart illustrating operations 600 of systems/methods for facilitating embodiments described herein.

FIG. 7 is a flowchart illustrating operations of systems/methods for facilitating embodiments described herein.

FIG. 8 is a flowchart illustrating operations for a gaming device according to some embodiments herein.

### DETAILED DESCRIPTION

Embodiments described herein may include community and/or tournament game features that can be offered through the metaverse and/or enhanced by introducing some metaverse features into community and/or tournament games so that they can be offered across different gaming channels beyond land-based casinos.

Such embodiments may take elements of traditional slot tournaments and/or community games and may use them in new ways by using the metaverse to deliver a new type of gaming experience. Embodiments may include multiple ways of implementation. can be implemented/. For example, a tournament and/or community game may be offered purely in an online/virtual casino in the metaverse. According to other examples, tournaments and/or community games can be linked together across multiple gaming channels including, for example, land-based casino, online casino, VLT, etc., so that players in these channels can participate in the tournaments and/or community games together at the same time from different locations.

A feature of “out-of-revenue” tournament games is that the payment of entry fees and awarding of prizes are done separately from the game. For example, the payment of entry fees and/or the awarding of prizes may be manually performed by the casino staff. This may give more freedom in the design of the game since it may not be bound by the usual bet and award limits that apply to non-tournament games. The credits won may represent points rather than actual money and the player who earns the most points may win the tournament. The winning player may be awarded a prize, which may be funded by the entry fee and/or the casino's marketing budget.

A community game in a land-based casino may involve multiple EGMs linked together so that the players playing those EGMs can participate in a shared gaming experience. The links between EGMs may allow them to share information so that interaction can occur between them. The interaction in these types of games can involve competitive or cooperative features in the game (i.e., the players are either competing with each other to win a bonus prize or cooperating to win a shared bonus). The links between the games are typically facilitated by a controller/server that coordinates the competitive and/or cooperative elements in the game. A community game also may have some overhead video signage that displays content related to competitive and/or cooperative events happening in the community game.

Some embodiments herein may offer tournaments and/or community games through a virtual casino while maintaining the excitement, entertainment and interaction between players that may be experienced in a land-based casino environment. Some embodiments may expand the participation in a tournament and/or community game to a larger audience compared to a single land-based casino instance of the game. Some embodiments may leverage the unique capabilities of the metaverse to add new features and/or new types of experiences to tournaments and/or community games.

In some embodiments, tournaments and/or community games may be offered through virtual casinos in the metaverse. In some embodiments, tournaments and/or community games may be linked between the metaverse and land-based casinos so that both player groups can participate in the same game at the same time. In some embodiments, players may wager on outcomes of which player will win the tournament. For example, spectators may wager back bets on the outcome of the primary tournament and/or community game. This feature may be a feature that is available to players with extended experience.

Some embodiments include features like camera feeds and/or avatars to allow for greater interaction and feedback between players in the metaverse. In some embodiments, players may conduct individual and/or group chat sessions with each other. Some embodiments may include artificial intelligence for providing simulated audience/crowd members (i.e., “non-player characters”) to add to the excitement by creating the illusion of a larger crowd. Some embodiments include AI-driven artificial host/MC/presenter who “oversees” the game and provides simulated reactions to the actions of real players and game events. In some embodiments, semi-autonomous animated player avatars may show a player's reactions to the other players. For example, the player could select a reaction (happy, excited, etc.) from a simple menu or toolbar, and the avatar would produce a simulated, but unique, reaction based on those simple inputs from the player. This feature may be attractive to players who are not comfortable showing their face via a webcam. In some embodiments, AI can be used to make the reactions context-sensitive by tailoring them to in-game events.

In some embodiments, the player avatar may be controlled by analyzing the player's expressions from their webcam and duplicating them virtually. For example, other players may only see the avatar, not the player's camera feed.

In some embodiments, the Metaverse may provide an online virtual environment where gambling-oriented tournaments and community games may be played. In some embodiments, the virtual environment may be a stand-alone virtual casino, and/or a larger virtual environment that includes one or more virtual casinos along with other non-casino features. Some embodiments may offer a new stage environment that has special seating, machine set up, and/or lighting/music for a tournament.

Some embodiments provide that players can interact with each other in a general sense using camera video feeds, avatars, one-on-one video, voice and/or text chats. Embodiments may include a video camera that may show a wide-angle view of community and tournament participants and the audience from a land-based casino. Wide angle may provide that multiple players are shown at the same time versus individuals. In some embodiments, a wide-angle view may be desirable from a privacy perspective.

In some embodiments, individual players in the virtual casino may be seen via their own webcams if the player opts in, such as for security and/or privacy reasons. A video camera may allow for real time action for back betting players to have a zoomed in level of spectatorship. The player's webcam may be used as an input device to control an animated player avatar. AI can analyze the video image and translate the player's reactions into the player avatar's reactions. Some embodiments provide that the avatar is what other players would see. In some embodiments, a camera may be used to invent an avatar.

Embodiments herein may include Artificial Intelligence (AI) that may create simulated audience members for the game, with realistic reactions to game events and player actions and/or use AI to create a simulated host/presenter/MC for the game, with realistic reactions to game events and player actions. The AI may be used to analyze a player's webcam feed and translate the player's reactions into the player avatar's reactions.

In some embodiments, a tournament and/or community game may use the metaverse to provide new gaming experiences to players of tournament and/or community games. In some embodiments, a tournament and/or community game can be offered purely in an online/virtual casino in the metaverse. In such embodiments, the players may be using a computer and/or mobile device to connect to an online virtual casino that offers tournament and/or community games.

In some other embodiments, tournaments and/or community games can be linked together across multiple gaming channels (land-based casino, online casino, VLT, etc.) so that players in these channels can participate in these games together at the same time from different locations. Such embodiments may provide that players in land-based casinos and/or VLTs may also participate in the games along with the players who are connecting remotely to a virtual casino.

In some embodiments, the players who participate in these games may be playing together competitively, cooperatively and/or otherwise interacting with a shared gaming experience even though they may be physically located in different places. Because some or all of the players may not be physically located together, the virtual environment includes features that facilitate interaction between the players and that replicate the sense of excitement that land-based multiplayer games offer.

Some embodiments provide that interactivity between players may provide remote players with interaction comparable to in-person game play. In some embodiments, audio-video feeds may allow the players to see and hear each other. Some embodiments provide that this may be optional for privacy reasons. The audio-video feeds may be live continuously during game play, and/or the players can use it for one-on-one and/or group chats. A text chat feature may allow players to interact at their own pace and with greater privacy. Animated player avatars are used to provide visual interaction with greater privacy than a video feed. The avatars can also offer customization (such as apparel or accessories), which may be won in games and/or purchased. When combined with a camera feed as input, the avatars can use artificial intelligence to replicate the player's mood and reactions.

In some embodiments, virtual events may allow the remote players to organize and participate in virtual social gaming events in a virtual casino environment. These events can be private and/or semi-private to provide an exclusive gaming experience for the participants. Casinos, gaming vendors and others may organize virtual events as a marketing tool to showcase gaming products to customers, players or influencers. For example, the organizer can assemble a list of invitees for the event. The invitee list may include specific people or categories of people, such as, for example, players club members, players with certain game play characteristics, and/or influencers, among others.

The organizer of the virtual event can customize it to make it more personal or more suitable for their needs. For example, the selection of games available at the event can be tailored to their wishes, and the appearance of the casino environment itself can be customized.

Some embodiments herein may provide enhancement of the gaming experience. For example, remote players may be provided with a greater sense of excitement by using AI to provide simulated spectators and/or a simulated host. In some embodiments, these non-player characters may use AI to provide realistic reactions to events in the game and to the actions of the real players.

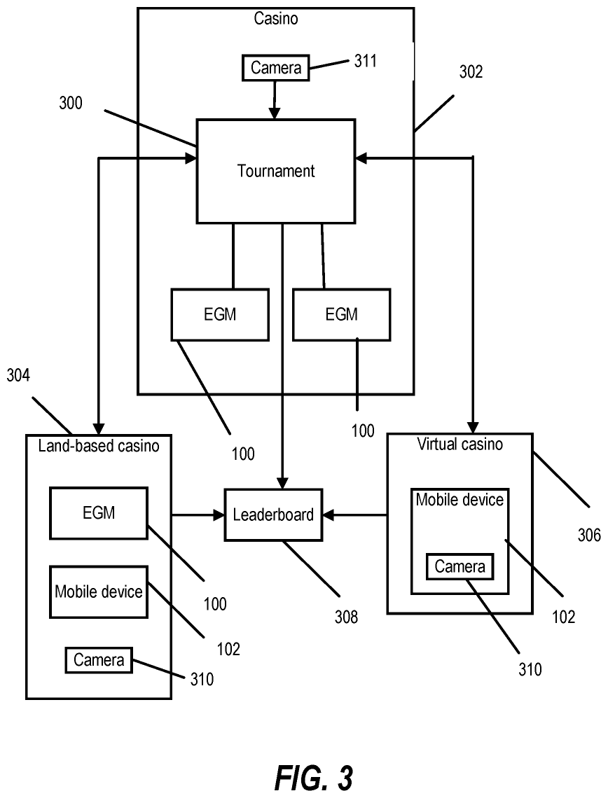

Brief reference is now made to FIG. 3, which is a schematic block diagram illustrating providing shared tournaments between two or more gaming channels according to some embodiment herein. For example, a single tournament 300 may span one or more land-based casinos 302, 304 and an online and/or virtual casino 306 such that all participants may compete against each other to win the tournament. A leaderboard 308 may display top scores, regardless of where the participants are playing. Some embodiments provide visual indicators/icons next to each player's name that may indicate which casino they are in including both land-based casinos and/or online-casinos, such as virtual casinos, among others.

In some embodiments, video/camera feeds provided by cameras 310 may show participants in tournaments and/or community gaming. Video feeds may be displayed on overhead signage in land-based casinos may show the participants in the game that are in different locations than the land-based casinos. In some embodiments, camera feeds may be provided for tournament banks in land-based casinos so players in other locations can see the participants in other locations. In some embodiments, a wide-angle feed 311 may show an entire group instead of individual player feeds. In some embodiments, an optional webcam feed for online casino players may be included and may be optionally shown to other participants. Some embodiments provide that online players may also have the option of just showing an avatar image or profile picture if they choose to include a live video feed. In some embodiments, player avatars may be animated to simulate responses to game events. Some embodiments provide that a player may be allowed to select the responses manually from a menu and/or allow for automatic responses, such as excitement for a big game win.

Some embodiments include private and semi-private virtual casinos, which may be provided as a community gaming feature. In some embodiments, players may book an online casino for a private event. In some embodiments, only invited players can attend and individual players may use these types of events for gatherings/parties of friends, family, coworkers, or other acquaintances. In some embodiments, gaming vendor may use this type of event to promote products to customers, industry insiders/analysts, and/or influencers, among others. Some embodiments provide that a casino (online and/or land-based) may use this type of event to promote their casino to players club members, and/or investors, among others.

Some embodiments provide that attendees can play single-player games individually, while community games with shared experiences may be offered so groups of players can play together.

In some embodiments, group chats (e.g., text, voice and/or video) may be available to allow for socializing, deciding what games to play, giving presentations, and/or making announcements, among others. In some embodiments, an event organizer may specify specific game themes and/or categories of games that will be featured prominently during the event. Some embodiments provide that other games may still be available but may be featured less prominently.

Some embodiments provide that an event organizer may limit the selection of games to a specific list to allow a casino and/or gaming vendor to showcase specific games at the event.

In some embodiments, an AI-based non-player character may be added in order to create more excitement by simulating a larger crowd. This may help replicate the typical casino experience that includes a lot of background sights and sounds coming from the players and the games in a big casino.

Some embodiments provide that players can book an online casino for a semi-private event that may be for invited players plus other players that meet certain specified criteria, including, for example, influencers, celebrities, high rollers, and/or other exclusive player categories, among others. Other features as disclosed above may also be applicable to these embodiments.

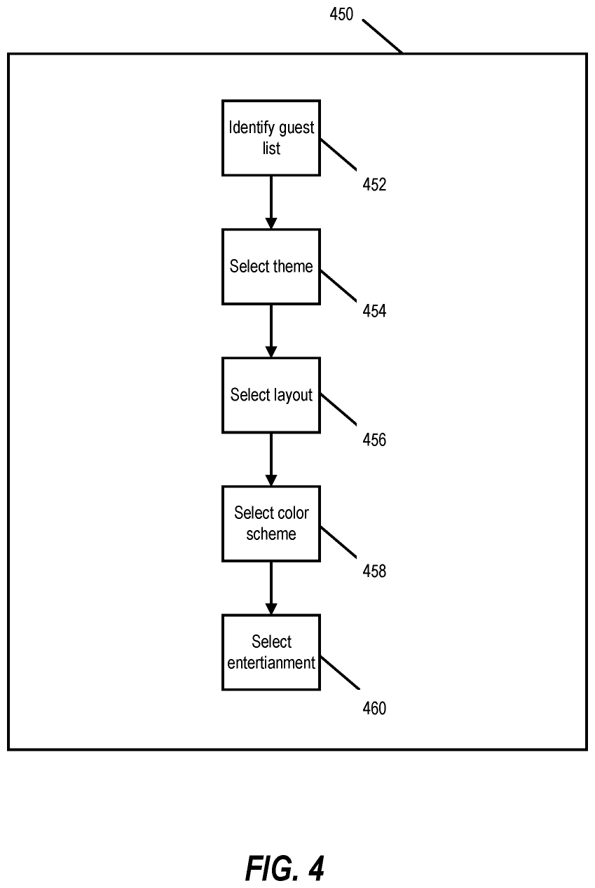

Some embodiments include a customized virtual casino in which the entire casino experience may be customized by an event coordinator. Brief reference is now made to FIG. 4, which is a schematic block diagram illustrating a graphical user interface (GUI) for customizing a virtual casino according to some embodiments herein. In some embodiments, the GUI 450 includes an input for identifying a guest list (block 452) corresponding to a tournament and/or a community gaming event. A theme may be selected (block 454) and a virtual casino layout may be selected (block 456). Some embodiments provide that a color scheme (block 458) may be selected. For example, some embodiments provide that theme and/or decoration of the virtual casino may be customized by choosing color scheme, graphics, walls, and/or carpets, among others. Embodiments provide that a layout/organization of the virtual casino (block 458) may be customized using a level editor or other type of application that is similar to other types of on-line games. Some embodiments provide that virtual entertainment may be selected (block 460) offered, such as, for example, a video feed of a live or pre-recorded band playing, an AI-based virtual MC to make announcements, and/or a video feed of a live MC to make announcements, among others.

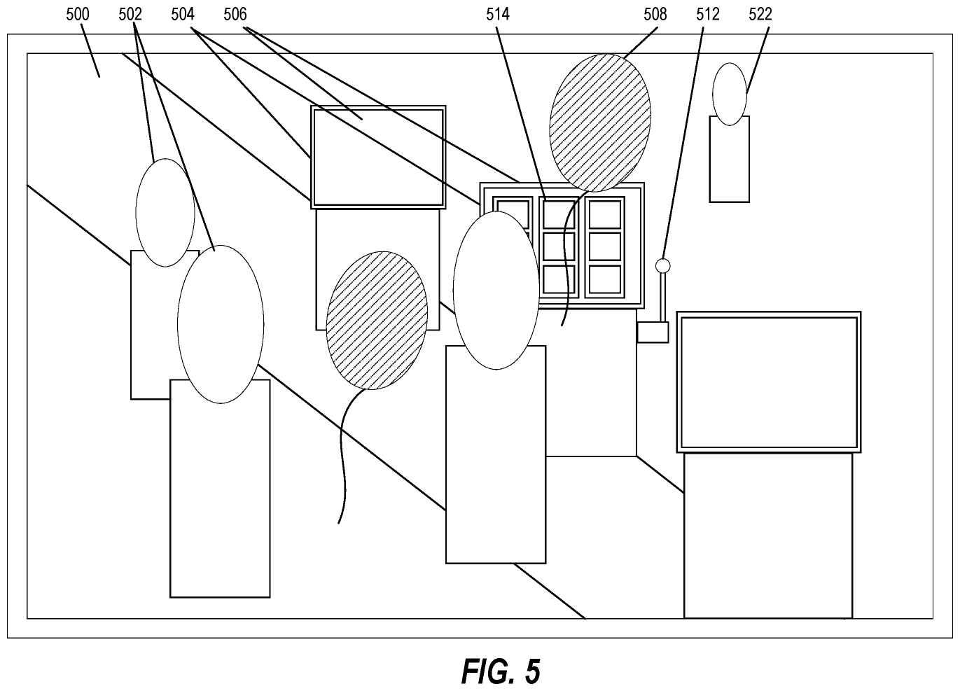

Briefly referring now to FIG. 5, a shared virtual environment (SVE) 500 comprising a virtual casino is illustrated according to some embodiments. The SVE 500 may include a plurality of virtual players 502 playing in a tournament and/or community game and a plurality of virtual gaming devices 504, including one or more virtual EGMs 506. In addition to the virtual players, one or more spectators 522 may be in the virtual environment and may be able to place wagers regarding the outcome of the tournament and/or community game.

In some embodiments, display data corresponding to the SVE 500 may be transmitted to a headset as described herein, including user display data that causes the headset to render a portion of the SVE 500 based on a virtual orientation of the headset and a virtual location of the player in the SVE 500.

In some embodiments, a virtual object 508 may be associated with a game win celebration. For example, a virtual balloon 520 associated with a win at the virtual EGM 506 may be visible to the players 502 and/or spectators 522 and/or other virtual gaming devices via different channels. In some examples, a virtual object 508 may include a virtual slot machine handle 512 for the virtual EGM 506 for a virtual pull of the virtual slot machine handle 512 by the player 502. In some embodiments, the virtual object may include a spinning virtual slot reel 514 by virtually touching the virtual slot reel 514 by the player 502 and by causing the virtual slot reel 514 to stop spinning and generate a virtual wagering game result.

As briefly described above, embodiments herein may provide back-betting in which players may be allowed to wager on their favorite players and their standings in the tournament or community feature. In some embodiments, the audience or other non-tournament participant, may be allowed to wager on the outcome of a tournament/community participant. Some embodiments include a video and/or VR environment may allow audience members to attend the ‘live’ tournament/community event. In some embodiments, chat room and discussion boards may be available. Further, stats on players who are entering may be made available for the audience to wager on. Examples of player data may include name/nickname, number of tournaments the player has played in, the performance of the player such as quantity and/or percentage won, and/or ranking, among others.

Some embodiments may provide real-time updates, notifications, and/or other attention-grabbing mechanisms to engage participation. In some embodiments, regardless of which channel you participated previously, real-time notifications may be provided while not gambling on a mobile device. For example, an announcement may include identifiers such as which casino and when the tournament and/or community game is being played, how to sign-up and when to sign up.

In some embodiments, a player may be able to “reserve a slot” this way, and be able to select from which channel they want to participate. Some embodiments provide that, while gambling, in-game notifications may be shown and sign up may be provided. In some embodiments, a player may be able to, select a metaverse participation directly from an EGM in the casino. Some embodiments may provide a calendar sync with a mobile device from any channel based on personal sign-ups. Some embodiments may provide personalized advertisement on either channel that may be based on preferred/previous participations. Operations may further include a participation history, showing all of a player's participations, including when, from which channels, whom was played, and/or what the outcome was, among others, on either mobile device or any on the participating channel's devices.

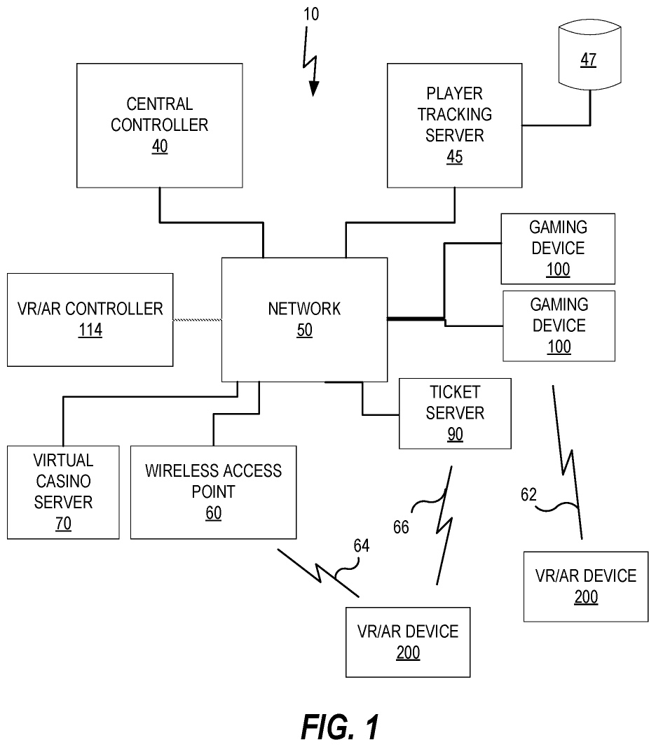

Before discussing these and other embodiments in greater detail, reference will be made to an example of a gaming system for implementing embodiments disclosed herein. In this regard, FIG. 1 illustrates a gaming system 10 including a plurality of gaming devices 100 is illustrated. As discussed above, the gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

The wireless interfaces 62, 66 allow a plurality of virtual reality (VR) and/or augmented reality (AR) devices, referred to herein as VR/AR devices 200, to coordinate the generation and rendering of VR and/or AR images to the player. As used herein, VR/AR devices 200 may include VR and/or AR functionality, as desired. In some embodiments, the gaming system 10 includes a VR/AR controller 114. The VR/AR controller 114 may be a computing system that communicates through the data communication network 50 with the EGMs 100 and the VR devices 200 to coordinate the generation and rendering of virtual images to one or more players using the VR devices 200. The VR/AR controller 114 may be implemented within or separately from the central controller 40.

In some embodiments, the VR/AR controller 114 may coordinate the generation and display of the virtual images of the same virtual object to more than one player by more than one VR/AR device 200. As described in more detail below, this may enable multiple players to interact with the same virtual object together in real time. This feature can be used to provide a shared multiplayer experience to multiple players at the same time.

Moreover, in some embodiments, the VR/AR controller 114 may coordinate the generation and display of the same virtual object to players at different physical locations, as will be described in more detail below.

The VR/AR controller 114 may store a three-dimensional wireframe map of a gaming area, such as a casino floor, and may provide the three-dimensional wireframe map to the VR/AR devices 200. The wireframe map may store various information about EGMs in the gaming area, such as the identity, type and location of various types of EGMs. The three-dimensional wireframe map may enable a VR/AR device 200 to more quickly and accurately determine its position and/or orientation within the gaming area, and also may enable the VR/AR device 200 to assist the player in navigating the gaming area while using the VR/AR device 200. The generation of three-dimensional wireframe maps is described in more detail below.

In some embodiments, at least some processing of virtual images and/or objects that are rendered by the VR devices 200 may be performed by the VR/AR controller 114, thereby offloading at least some processing requirements from the VR devices 200.

One or more servers, such as a virtual casino server 70, may also be connected through the data communication network 50. Similarly, the virtual casino server 70 may manage delivery of the gaming content corresponding to a virtual casino to the user of a gaming device 100. The gaming content may be stored in a gaming content database 85. Virtual casino server 70 and other servers may be implemented within or separately from each other. The virtual casino server 70 may also be implemented within or separately from the central controller 49.

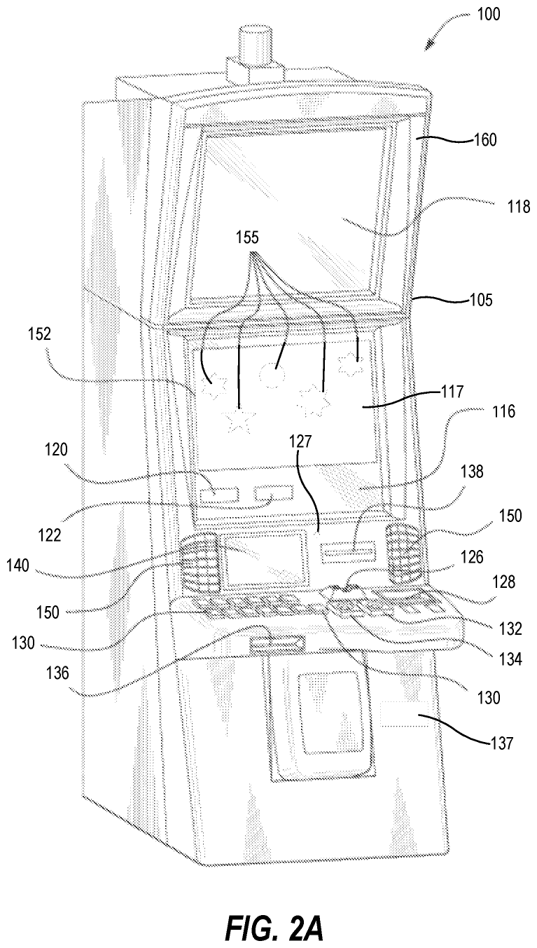

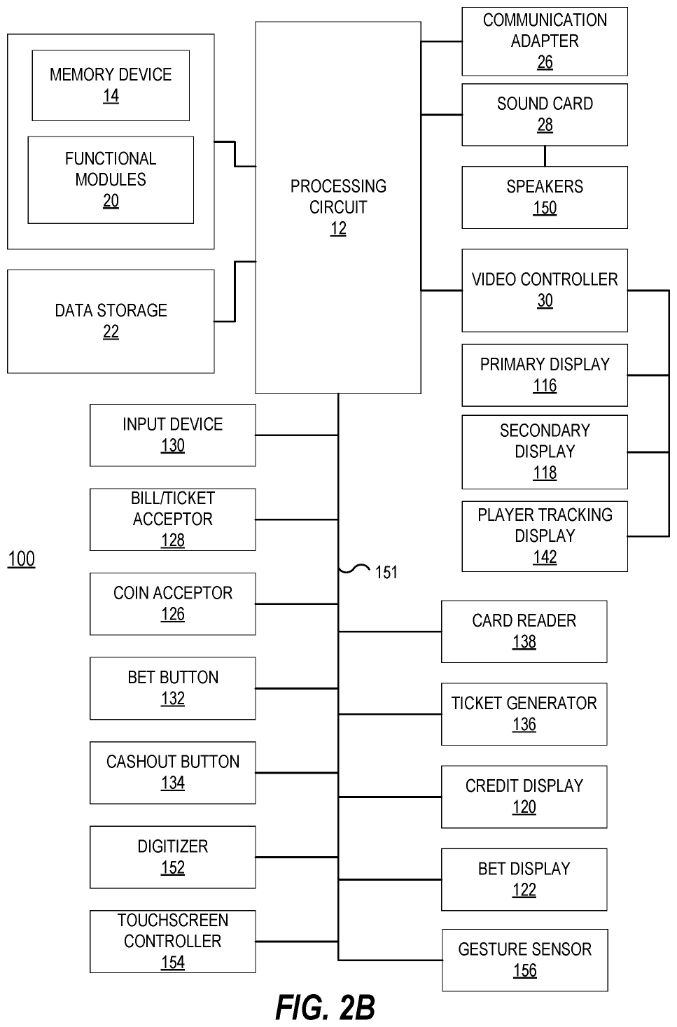

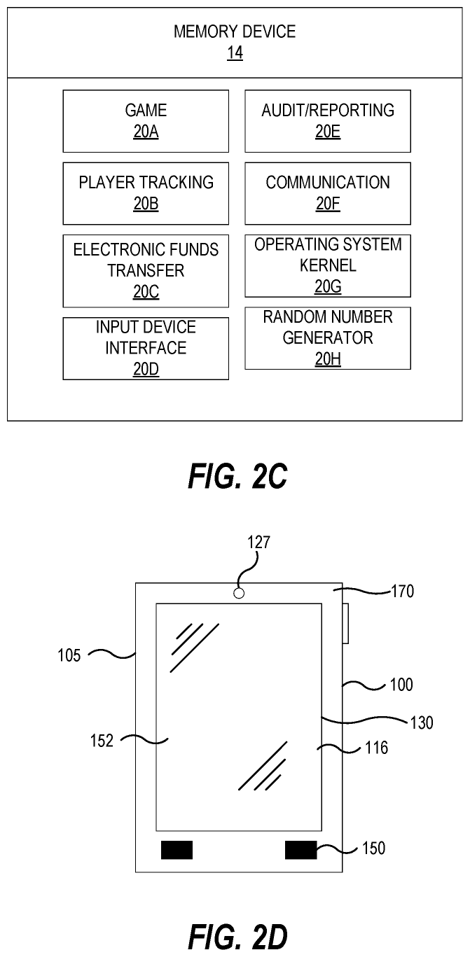

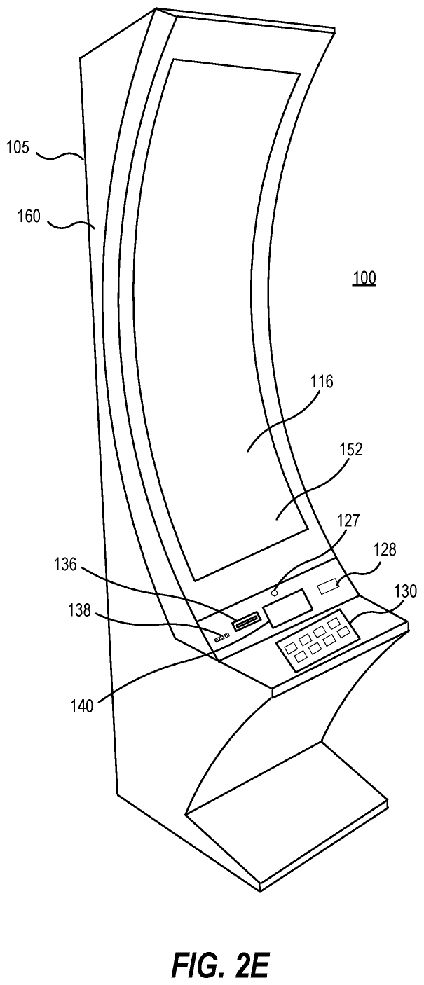

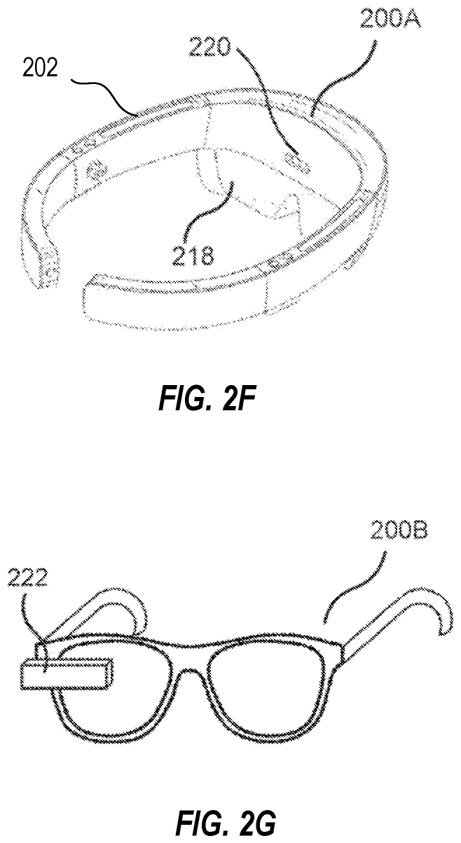

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering and/or betting function is a bet repeat device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller.” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

FIG. 2F illustrates a virtual reality (VR) viewer 200A implemented as a 3D headset including a pair of displays 218 on which images of virtual objects may be displayed. The viewer 200A includes a head-wearable frame 202, with the displays 218 coupled to the frame 202 to position the display device in a field of view of user wearing the viewer 200A. Different stereoscopic images may be displayed on the displays 218 to create an appearance of depth. The VR viewer 200A may include a plurality of sensors 220 that the device uses to determine a position, orientation, and/or movement of the viewer 200A, which may be used to determine a position, orientation, and/or direction of movement within an SVE.

The viewer 200A may further include other sensors, such as a gyroscopic sensor, a GPS sensor, one or more accelerometers, and/or other sensors that allow the viewer 200A to determine its position and orientation in space. In some embodiments, the viewer 200A may include one or more cameras that allow the viewer 200A to determine its position and/or orientation in space using visual simultaneous localization and mapping (VSLAM). viewer 200A may further include one or more microphones and/or speakers that allow the user to interact audially with the device.

In some embodiments, a viewer may also include semitransparent lenses that allow the user to see both the real world as well as the 3D image rendered on the lenses, e.g., to provide an augmented reality (AR) experience. The viewer may also include additional cameras or other sensors to obtain a live video signal for building a 3D model of the space around the user. The viewer may also generate a 3D image of an object to display to the user that takes into account the real world objects around the user and allows the user to interact with the 3D object.

Referring to FIG. 2G, an augmented reality (AR) viewer 200B may be implemented as a pair of glasses including a transparent prismatic display 222 that displays an image to a single eye of the user. Such a device may be capable of displaying images to the user while allowing the user to see the world around the user, and as such can be used as an AR device.

In other embodiments, a VR and/or AR viewer may be implemented using a virtual retinal display device that raster scans an image directly onto the retina of the user. In still further embodiments, a VR and/or AR viewer may be implemented using a mobile wireless device, such as the mobile gaming device 170 of FIG. 2D above, a mobile telephone, a tablet computing device, and/or a personal digital assistant, etc.

Although illustrated as certain gaming devices, such as electronic gaming machines (EGMs), mobile gaming devices, VR/AR headsets, etc., functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

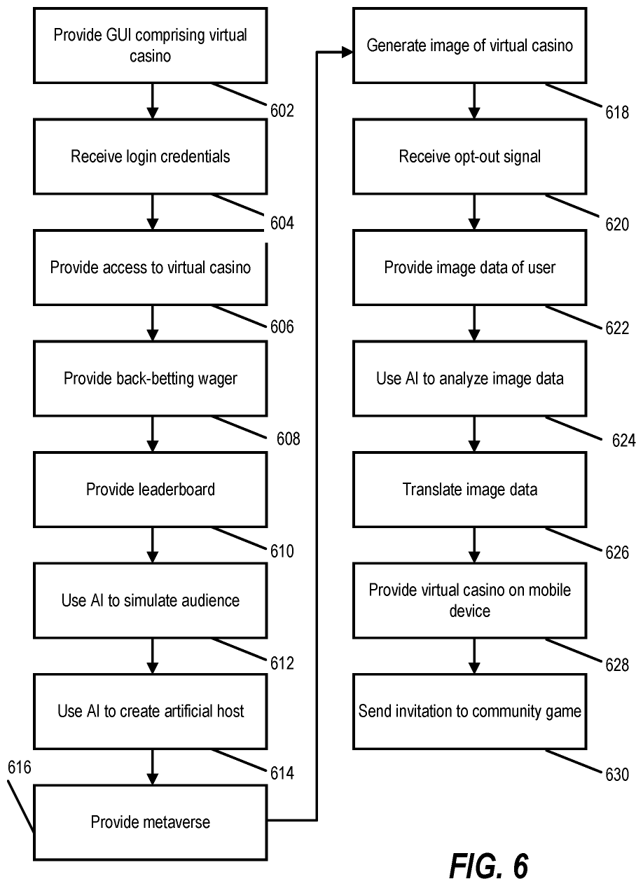

Reference is now made to FIG. 6, which is a flowchart illustrating operations 600 of systems/methods for facilitating embodiments described herein. The operations include providing (block 602) a graphical user interface (GUI) that includes a virtual casino. Some embodiments provide that the virtual casino may be accessed by multiple users simultaneously. For example, multiple users may participate in an on-line tournament and/or a community game. Operations may include receiving (block 604) login credentials from the multiple users. The login credentials may be evaluated and, based on the login credentials being valid, the user may be provided (block 606) with access to the virtual casino. Some embodiments provide that access to the virtual casino may be provided using multiple different gaming channels. Gaming channels may include channels between the virtual casino and a land-based EGM in the same physical location, land-based EGM's in different physical locations, mobile computing devices located locally and/or mobile computing devices that are remotely located.

Operations may provide that the gaming channels include a first gaming channel that is a first gaming channel type and a second gaming channel that is a second gaming channel type that is different from the first gaming channel type. For example, the first channel type may include an EGM in a casino and a second channel type may be a mobile computing device that is remote from the EGM. Operations may include providing (block 608) a back-betting wager. In some embodiments, the back-betting wager may include a wager having an outcome that is determined based on the outcome of the tournament and/or community game. For example, a back-betting wager may be made for a spectator to wager on an outcome of the tournament. Embodiments further provide that the system may receive an input that corresponds to the spectator accepting the back-betting wager; and, based on the outcome of the tournament, providing an award to the spectator.

In some embodiments, operations include providing (block 610) a leaderboard that includes performance data of the users in the tournament. In some embodiments the leaderboard may be available for spectators or other non-user audience members in the virtual casino. For example, in some embodiments, a leaderboard may be visible in the virtual casino at mobile computing devices. For example, a GUI on a mobile computing device may include a portion that displays data corresponding to the users and/or audience members.

Some embodiments include using (block 612) artificial intelligence to provide a simulated audience in the virtual casino by providing one or more non-player characters. In some embodiments the non-player characters may react to events in the game to increase excitement and/or to increase user immersion in the tournament and/or community game.

In some embodiments, artificial intelligence may be used to provide (block 614) an artificial host in the virtual casino. In some embodiments, the artificial host may oversee events in the virtual casino and may provide simulated reactions to actions of the plurality of users while in the virtual casino and/or other events in the virtual casino.

Operations may include providing (block 616) a metaverse that includes multiple different virtual casinos and one or more non-casino features that is provided via a different gaming channel than a casino gaming channel. The virtual casino and other metaverse experiences can be provided through a variety of devices and technologies, such as virtual reality (VR), augmented reality (AR), personal computing devices, mobile computing devices, home entertainment technologies such as smart televisions and/or set-top boxes, etc.

In some embodiments, image data corresponding to the users may be received and generated by image capture devices corresponding to the users. In some embodiments, operations include generating (block 618) an image in the virtual casino that is associated with respective ones of the user. Some embodiments provide that some users may have privacy concerns and prefer not to have their image shown. In such embodiments, operations may include receiving (block 620) an opt-out signal from one of the users that causes the image data not to be captured, displayed and/or stored.

Operations may include providing (block 622) image data received from an image capture device of one of the users with other ones of the users in the virtual casino.

Some embodiments provide using artificial intelligence (block 624) to analyze image data generated by an image capture device corresponding to one of the users. For example, the image capture device may be a camera in a mobile computing device, among others. Some embodiments provide translating (block 626) the image data into a reaction of an avatar that corresponds to the one of the users in the virtual casino.

Operations may include providing (block 628) the virtual casino to one of the users via a mobile communication device that is associated with the one of the users.

Operations may include sending (block 630) an invitation message corresponding to a community game to the users and receiving an acceptance message from the users. In some embodiments provide that the virtual casino includes the community game that is exclusively accessible to the users that are invited to participate in the virtual casino. Some embodiments provide that the community game provides multiple game channel types to the users. In some embodiments, the community game includes a first community game and the virtual casino includes a second community game that is different from the first community game. In embodiment, the first community game and the second community game are linked together across the gaming channels.

In some embodiments, the virtual casino includes a land-based physical casino and an on-line casino that provide a shared gaming experience to the users.

In some embodiments, the virtual casino is provided to the users via a virtual reality (VR) device that is associated with one of the users.

Operations may include receiving customized data corresponding to the virtual casino and providing a custom virtual casino that includes characteristics corresponding to the customized data.

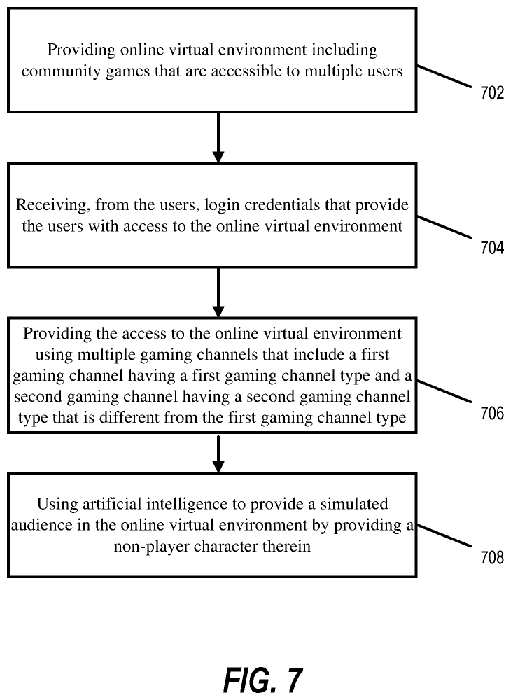

Brief reference is now made to FIG. 7, which is a flowchart illustrating operations of systems/methods for facilitating embodiments described herein. The operations include providing (block 702) an online virtual environment that includes community games that are accessible to multiple users and receiving (block 704), from the users, login credentials that provide the users with access to the online virtual environment. Operations may include providing (block 706) access to the online virtual environment using multiple gaming channels that include a first gaming channel having a first gaming channel type and a second gaming channel having a second gaming channel type that is different from the first gaming channel type. In some embodiments, AI may be used (block 708) to provide a simulated audience in the online virtual environment by providing a non-player character therein.

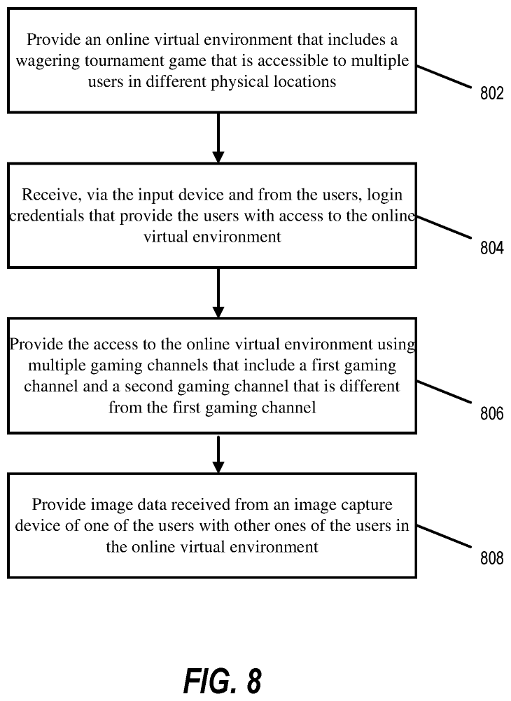

Brief reference is now made to FIG. 8, which is a flowchart illustrating operations for a gaming device according to some embodiments herein. The gaming device may include an input device, a processor circuit, and a memory coupled to the processor circuit. The memory includes machine-readable instructions that, when executed by the processor circuit, cause the processor circuit to perform operations including providing (block 802) an online virtual environment that includes a wagering tournament game that is accessible to multiple users in different physical locations. Operations may further include receiving (block 804), via the input device and from the users, login credentials that provide the users with access to the online virtual environment. Operations may include providing (block 806) access to the online virtual environment using multiple gaming channels. Some embodiments provide that the multiple gaming channels include a first gaming channel and a second gaming channel that is different from the first gaming channel. Operations include providing (block 808) image data received from an image capture device of one of the users with other ones of the users in the online virtual environment.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
provide a graphical user interface (GUI) comprising a virtual casino that is accessed by a plurality of users;
receive, from the plurality of users, login credentials that provide the plurality of user with access to the virtual casino; and
provide the access to the virtual casino using a plurality of gaming channels.

2. The system of claim 1, wherein the plurality of gaming channels comprises a first gaming channel comprising a first gaming channel type and a second gaming channel comprising a second gaming channel type that is different from the first gaming channel type.

3. The system of claim 1, wherein the virtual casino comprises a tournament that is playable by the plurality of users.

4. The system of claim 3, wherein the processor circuit is further caused to: provide a back-betting wager for a spectator to wager on an outcome of the tournament; receive an input that corresponds to the spectator accepting the back-betting wager; and, based on the outcome of the tournament, providing an award to the spectator.

5. The system of claim 3, wherein the leaderboard provides performance data of the plurality of users in the tournament to non-user audience members in the virtual casino.

6. The system of claim 1, wherein the processor circuit is further caused to use artificial intelligence to provide a simulated audience in the virtual casino by providing a non-player character therein.

7. The system of claim 1, wherein the processor circuit is further caused to use artificial intelligence to provide an artificial host in the virtual casino, and wherein the artificial host is caused to oversee events in the virtual casino and to provide simulated reactions to actions of the plurality of users while in the virtual casino.

8. The system of claim 1, wherein the processor circuit is further caused to provide a metaverse that comprises plurality of different virtual casinos and a non-casino feature that is provided via a different gaming channel than a casino gaming channel.

9. The system of claim 1, wherein the processor circuit is further caused to: receive image data corresponding to the plurality of users and generated by image capture devices corresponding to the plurality of users; generate an image in the virtual casino that is associated with respective ones of the plurality of users; and receive an opt-out signal from one of the plurality of users that causes the image data not to be captured.

10. The system of claim 1, wherein the processor circuit is further caused to provide image data received from an image capture device of one of the plurality of users with other ones of the plurality of users in the virtual casino.

11. The system of claim 1, wherein the processor circuit is further caused to use artificial intelligence to: analyze image data generated by an image capture device corresponding to one of the plurality of users; and translate the image data into a reaction of an avatar that corresponds to the one of the plurality of users in the virtual casino.

12. The system of claim 1, wherein the processor circuit is further caused to provide the virtual casino to one of the plurality of users via a mobile communication device that is associated with the one of the plurality of users.

13. The system of claim 1, wherein the processor circuit is further caused to send an invitation message corresponding to a community game to the plurality of users and to receive an acceptance message from the plurality of users, wherein the virtual casino comprises the community game that is exclusively accessible to the plurality of users that are invited to participate in the virtual casino.

14. The system of claim 13, wherein the community game provides a plurality of game channel types to the plurality of users.

15. The system of claim 13, wherein the community game comprises a first community game and wherein the virtual casino comprises a second community game that is different from the first community game, and wherein the first community game and the second community game are linked together across the plurality of gaming channels.

16. The system of claim 1, wherein the virtual casino comprises a land-based physical casino and an on-line casino that provide a shared gaming experience to the plurality of users.

17. The system of claim 1, wherein the processor circuit is further caused to provide the virtual casino to the plurality of users via a virtual reality (VR) device that is associated with one of the plurality of users.

18. The system of claim 1, wherein the processor circuit is further caused to receive customized data corresponding to the virtual casino and to provide a custom virtual casino that includes characteristics corresponding to the customized data.

19. A method comprising:
providing an online virtual environment that comprises community games that are accessible to a plurality of users;
receiving, from the plurality of users, login credentials that provide the plurality of users with access to the online virtual environment;
providing the access to the online virtual environment using a plurality of gaming channels that comprises a first gaming channel comprising a first gaming channel type and a second gaming channel comprising a second gaming channel type that is different from the first gaming channel type; and
using artificial intelligence to provide a simulated audience in the online virtual environment by providing a non-player character therein.

20. A gaming device comprising:
an input device;
a processor circuit; and
a memory coupled to the processor circuit, the memory comprising machine-readable instructions that, when executed by the processor circuit, cause the processor circuit to:
provide an online virtual environment that comprises a wagering tournament game that is accessible to a plurality of users in different physical locations;
receive, via the input device and from the plurality of users, login credentials that provide the plurality of users with access to the online virtual environment;
provide the access to the online virtual environment using a plurality of gaming channels that comprises a first gaming channel and a second gaming channel that is different from the first gaming channel; and
provide image data received from an image capture device of one of the plurality of users with other ones of the plurality of users in the online virtual environment.
